(19) United States
(12) Patent Application Publication
(10) Pub. No.: US 2026/0209996 A1
(43) Pub. Date: Jul. 23, 2026

(54) COMPOUND PHOSPHORUS-NITROGEN FLAME RETARDANT, FLAME-RETARDANT REGENERATED CELLULOSE FIBER, AND PREPARATION METHOD

(71) Applicant: CHINA TEXTILE ACADEMY, BEIJING (CN)

(72) Inventors: Min GAO, BEIJING (CN); Qingbo ZHAO, BEIJING (CN); Shuli WANG, BEIJING (CN); Zhongkai XU, BEIJING (CN); Chunzu CHENG, BEIJING (CN); Chenxi ZHANG, BEIJING (CN); Ting LI, BEIJING (CN); Jigang XU, BEIJING (CN); Kedong CHI, BEIJING (CN)

(73) Assignee: CHINA TEXTILE ACADEMY, BEIJING (CN)

(21) Appl. No.: 19/141,234

(22) PCT Filed: Apr. 19, 2023
(86) PCT No.: PCT/CN2023/089164

§ 371 Date: Jun. 19, 2025

(30) Foreign Application Priority Data
Dec. 21, 2022 (CN) 202211650189.X

(51) Int. Cl. D01F 1/07; D01F 2/24; D01F 11/02

(52) U.S. Cl. CPC D01F 1/07; D01F 2/24; D01F 11/02

(57) ABSTRACT

The present invention discloses a compounded phosphorus-nitrogen-based flame retardant, flame-retardant regenerated cellulose fiber, and preparation method thereof. The compounded phosphorus-nitrogen-based flame retardant comprises a compounded mixture of a phosphoramide ester compound and an inorganic compound, wherein a mass ratio of the two is (10-35):(0.1-10); components of the flame-retardant regenerated cellulose fibers comprise cellulose and the compounded phosphorus-nitrogen-based flame retardant dispersed within a cellulose fiber matrix. A preparation method of the compounded phosphorus-nitrogen-based flame retardant comprises: adding a dispersing aid to a dispersion medium and mixing uniformly, then adding a phosphoramide ester compound, and uniformly dispersing by means of ultrasonic dispersion or mechanical stirring, followed by grinding; subsequently adding an inorganic compound and a modifying agent, and performing grinding to obtain a slurry of the compounded phosphorus-nitrogen-based flame retardant. In the compounded phosphorus-nitrogen-based flame retardant of the present invention, the components are synergistically compounded to achieve the purpose of high-efficiency flame retardancy and smoke suppression, and the prepared flame-retardant regenerated cellulose fibers are non-toxic and environmentally friendly, have a low smoke concentration upon combustion, and have permanent flame-retardant performance and excellent mechanical properties.

### TECHNICAL FIELD

The present invention belongs to the technical field of fiber preparation, and specifically relates to a compounded phosphorus-nitrogen-based flame retardant, flame-retardant regenerated cellulose fiber, and preparation method thereof.

### BACKGROUND

Regenerated cellulose fibers are prepared using natural cellulose as a raw material, and have excellent properties such as good spinnability, good moisture absorption and air permeability, good dyeing performance, and good drapability. However, regenerated cellulose fibers are flammable fibers, and flame-retardant modification thereof is an effective measure to improve their flame-retardant performance.

Currently, the flame-retardant modification technologies for regenerated cellulose fibers are mainly based on blend addition or flame-retardant finishing with halogen-based, organic phosphorus-based, or silicon-based flame retardants. However, due to the problems that traditional halogen-based and phosphorus-based flame retardants are mostly hygroscopic, have poor acid and alkali resistance, and poor compatibility with cellulose, flame-retardant regenerated cellulose fiber products are prone to phenomena such as flame retardant migration and exudation during subsequent use, which seriously affects the durability of the flame-retardant fibers, for example, the solutions disclosed in Chinese applications CN103541034A, CN106958143A, and CN108071014A.

In addition, halogen-based and organic phosphorus-based flame retardants release a large amount of smoke, and even toxic smoke, during combustion, and most deaths in fires are caused by smoke asphyxiation. Therefore, reducing the amount of smoke released has become a key issue to be considered in the modification of flame-retardant regenerated cellulose fibers.

Although silicon-based flame retardants are more environmentally friendly, their flame-retardant elements are relatively singular, requiring large amounts in actual use, and the flame retardants have poor mixing uniformity with the spinning solution, resulting in poor spinnability of the spinning solution and difficulty in achieving a balance between flame retardancy and mechanical properties of flame-retardant fibers, as disclosed in patent applications US20120258643A1, CN 101050559A, and CN 102352539A.

Based on this, there is a need to seek a flame retardant that can efficiently retard flames and suppress smoke, while also mixing uniformly with the spinning solution, having good spinnability, and producing flame-retardant fibers with a good balance of flame retardancy and mechanical properties, as well as excellent flame retardant durability.

In view of this, the present invention is especially proposed.

### SUMMARY

The technical problem to be solved by the present invention is to overcome the deficiencies of the prior art and provide a compounded phosphorus-nitrogen-based flame retardant, flame-retardant regenerated cellulose fiber, and preparation method thereof. In the present invention, the various flame-retardant elements in the compounded phosphorus-nitrogen-based flame retardant achieve synergistic flame retardancy and smoke suppression through efficient compounding. The flame retardant has a low addition amount, good dispersibility, and good compatibility with cellulose, ensuring both good spinnability of the spinning solution and good dispersibility and durability of the flame retardant in the fiber, thereby improving the mechanical properties and flame retardancy of the fiber. The flame-retardant fiber has a good balance of flame retardancy and mechanical properties, with excellent flame retardant durability.

In order to solve the above technical problem, a basic conception of the technical solution used in the present invention is as follows:

The first objective of the present invention is to provide a compounded phosphorus-nitrogen-based flame retardant, comprising a mixture of phosphoramide ester compounds and inorganic compounds, wherein the mass ratio of said phosphoramide ester compounds to inorganic compounds is (10-35):(0.1-10).

Preferably, the mass ratio of said phosphoramide ester compound and said inorganic compound is (10-30):(0.1-10).

More preferably, the mass ratio of said phosphoramide ester compound and said inorganic compound is (10-25):(0.1-10).

The compounded phosphorus-nitrogen-based flame retardant of the present invention comprises a mixture of phosphoramide ester compounds and inorganic compounds. The organic-inorganic compounded system can achieve an effective synergistic flame-retardant effect, utilizing both the high-efficiency flame retardancy of phosphoryl amide ester compounds and the low cost, non-toxic smoke suppression, and char promotion characteristics of inorganic compounds. By controlling the ratio between the two, the synergistic flame-retardant effect of the compounded system is enhanced, achieving good flame retardancy with a relatively small amount of flame retardant addition, while maintaining good fiber mechanical properties and low smoke density during combustion. Among them, inorganic compounds more easily achieve nanoscale particle size and readily form porous structures in the fiber, thus providing a good reinforcing effect, reducing the impact of flame retardant addition on the mechanical properties of the fiber, and providing a foundation for a good balance between flame retardancy and mechanical properties of the flame-retardant fiber. In the present invention, when the mass ratio of phosphoramide ester compounds to inorganic compounds is (10-35):(0.1-10), the synergistic compounding provides better flame retardancy and smoke suppression effects.

In a further solution, the structure of the phosphoramide ester compound is shown in formula (1):

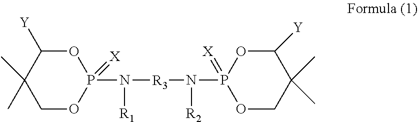

Where:

X is selected from oxygen or sulfur.

Y is selected from a hydrogen atom, an aryl group, or a methoxy group.

R₁ and R₂ are selected from an independent hydrogen atom, an alkyl group, an aryl group, a substituted alkyl group, or a substituted aryl group.

R3 is selected from an alkylene group, an aryl group, or a substituted aryl group.

Among them, R1, R2, R3, and a nitrogen atom connected thereto can form a nitrogen-containing heterocyclic structure.

In a further solution, the phosphoramide ester compounds include 1,2-bis(2-oxo-4-methoxy-5,5-dimethyl-1,3,2-dioxaphosphorinane-2-amino) ethane, 1,2-bis(2-oxo-5,5-dimethyl-1,3,2-dioxaphosphorinane-2-amino)benzoic acid, 1,2-bis(2-thio-5,5-dimethyl-1,3,2-dioxaphosphorinane-2-amino) ethane, 1,3-bis(2-oxo-5,5-dimethyl-1,3,2-dioxaphosphorinane-2-amino) hydroxypropane, 1,4-bis(2-oxo-4-methoxy-5,5-dimethyl-1,3,2-dioxaphosphorinane-2-amino) piperazine.

In a further solution, the inorganic compounds are selected from one or several mixtures of carbon compounds, clay minerals, silicon-based compounds, boron-containing compounds, and metal compounds.

In a further solution, the carbon compounds are selected from one or several of graphene, fullerene, carbon nanotubes.

Said clay mineral is selected from one or more of montmorillonite, kaolin, bentonite, talc, muscovite, and diatomaceous earth.

Said silicon-based compound is selected from one or more of silicon dioxide, sodium silicate, magnesium silicate, aluminum silicate, and calcium silicate.

Said boron-containing compound is selected from one or more of zinc borate and boron nitride.

Said metal compound is selected from one or more of titanium oxide, zinc oxide, magnesium oxide, aluminum sulfate, aluminum hydroxide, and magnesium hydroxide.

In a further solution, the inorganic compounds exist in particulate form, wherein the particles have an initial particle size distribution with X90 less than 50 μm; preferably, with X90 less than 10 μm; more preferably with X90 less than 5 μm.

In a further solution, the dispersing aid and modifying agent are included, wherein the mass ratio of phosphoramide ester compounds to the modifying agent is 1:(0.01-10); preferably 1:(0.01-5.0), more preferably 1:(0.01-2.0).

In a further solution, said dispersing aid is selected from a mixture of at least two or more of naphthalene sulfonates, sodium dodecylbenzene sulfonate, sodium alpha-olefin sulfonate, sodium lignosulfonate, sodium dodecyl sulfate, water-soluble polyesters, polycarboxylates, sodium polyacrylate, polyoxyethylene ether compounds, polyalkylsiloxane compounds, aliphatic-aromatic block copolymers, styrene-maleic anhydride modified copolymers, styrene-acrylic acid modified copolymers, sodium metaphosphate, sodium tripolyphosphate, and sodium pyrophosphate.

In a further solution, said modifying agent is at least one of an alkane compound or an organosilicon compound.

In a further solution, said alkane compound is a small molecule alkane compound containing an organic group; preferably, a small molecule alkane compound containing a small amount of carboxyl or mercapto groups.

In a further solution, said organosilicon compound is selected from a siloxane solution or a siloxane coupling agent; preferably, said siloxane solution is a polymerized or non-polymerized siloxane compound, preferably an oligosiloxane compound containing hydrogen, methoxy, ethoxy, etc.; said siloxane coupling agent is a siloxane coupling agent containing a methoxy, ethoxy, or acyloxy group, preferably a siloxane coupling agent containing a small amount of vinyl, amino, epoxy, or mercapto groups.

The second objective of the present invention is to provide a preparation method for the compounded phosphorus-nitrogen-based flame retardant, comprising: adding a dispersing aid to a dispersion medium and mixing uniformly, then adding a phosphoramide ester compound, uniformly dispersing for 0.5-5 h by means of ultrasonic dispersion or mechanical stirring, followed by performing a first grinding; subsequently adding an inorganic compound and a modifying agent, and performing a second grinding to obtain a slurry of the compounded phosphorus-nitrogen-based flame retardant.

In a further solution, the first grinding causes particles to have a particle size distribution with X10 of less than 1 μm and X90 of less than 10 μm; the second grinding is performed until the particles in the compounded flame retardant slurry have a particle size distribution with X10 of less than 0.5 μm and X90 of less than 5.0 μm.

The method of the present invention modifies the flame retardant system during the grinding process, effectively improving the hydrophobicity of the flame retardant system and its compatibility with cellulose macromolecules, thereby ensuring the durability of the flame-retardant regenerated cellulose fiber.

In the present invention, the preparation process of flame-retardant fibers involves blending and addition, with fiber diameters generally 10-20 μm, while the flame retardants are in powder form with large particle sizes and wide distribution. Therefore, it is necessary to use dispersants to grind and disperse the flame retardants, on one hand to reduce particle size and improve the incorporation rate of flame retardants, and on the other hand to improve the filterability and spinnability of the spinning solution and avoid agglomeration.

The present invention adopts a graded grinding method, i.e., first grinding the phosphoramide ester compounds to a certain particle size, then adding inorganic compounds and grinding to the required particle size. This not only improves the emulsification and uniform dispersion of the dispersion system but also ensures the uniform distribution of particle sizes of different flame retardant components in the flame retardant slurry, solving the technical problems of difficulty in direct blending of flame retardants with the spinning solution and poor filterability and spinnability of the spinning solution in the prior art.

In a further solution, the phosphoramide ester compounds are added directly, or are pretreated and modified before addition.

In a further solution, the pretreatment and modification method of the phosphoramide ester compounds comprises: uniformly dispersing the phosphoramide ester compound in a mixed solution of water and ethanol, then adding a silicate ester and a modifying agent, and pretreating at 25-70° C. for 0.5-12 h, followed by filtering, washing, and drying to obtain a modified phosphoramide ester compound.

The phosphoramide ester compounds provided by the present invention, after pretreatment and modification, form a stable protective film on the surface of the flame retardant particles due to the hydrolysis reaction of the modifying agent, effectively improving the hydrophobicity of the phosphoramide ester compounds, avoiding the migration and leaching of flame retardants during use and washing, and ensuring the water resistance and acid-alkali resistance of the flame-retardant fibers.

In the modification process of the flame retardant in the present invention, modifying agents can be directly added to modify the flame retardant (as in embodiment 1/2/5/6), or silicate ester can be added first, followed by modifying agents to modify the flame retardant (as in embodiment 3/4/7/8). The mechanism of action of silicate esters and modifying agents is hydrolysis and condensation reactions, i.e., first hydrolyzing to form corresponding hydroxylated products (silicic acid), then condensing (silicic acid with silicic acid or silicic acid with modifying agents) to form a three-dimensional silica network structure. Under the conditions of the present invention, this structure forms on the surface of the flame retardant, which is equivalent to covering the flame retardant surface with a hydrophobic protective film, thus giving the flame retardant a hydrophobic, wash-resistant effect. Regarding the differences between these two modification methods, modifying agents with special functional groups have faster hydrolysis and condensation reactions, and poor control of conditions can easily result in uneven modification of the flame retardant; silicate ester compounds can hydrolyze at room temperature, and the hydrolysis reaction is relatively mild and easy to control, therefore silicate ester compounds can be used to first form silicic acid, which then forms a uniform network structure with the modifying agent.

The pretreatment process mainly affects the flame retardancy and wash resistance of the flame-retardant fibers. Flame-retardant fibers prepared with pretreated flame retardants have better wash resistance on one hand due to the hydrophobicity of the flame retardants and reduced water solubility, and on the other hand, the pretreated flame retardants have a certain binding force with the fibers, thus the fibers have better water wash resistance.

In a further solution, in said mixed solution of water and ethanol, a volume ratio of water to ethanol is 1:(0.1-10).

In a further solution, said silicate ester is at least one of tetraethyl orthosilicate, tetramethyl orthosilicate, tetrapropyl orthosilicate, or tetrabutyl orthosilicate.

In a further solution, a mass ratio of said phosphoramide ester compound to said silicate ester is 1:(0.1-10).

In a further solution, a mass ratio of said phosphoramide ester compound to said modifying agent is 1:(0.01-10); preferably, the mass ratio is 1:(0.01-5.0), more preferably; the mass ratio is 1:(0.01-2.0).

In a further solution, said modifying agent is added in the form of an ethanol solution, wherein in said ethanol solution, a molar concentration of the modifying agent is 0.01-1 mol/L, preferably 0.01-0.1 mol/L.

In a further solution, in said slurry of the compounded phosphorus-nitrogen-based flame retardant, a total mass of said phosphoramide ester compound, said inorganic substance, and said modifying agent accounts for 10-30% of a total mass of the slurry, a mass of the dispersing aid accounts for 0.5-20% of the total mass of the slurry, and the remainder is a dispersion medium.

In a further solution, said dispersion medium is at least one of deionized water, an ethanol solution, or an N-methylmorpholine-N-oxide solution.

The third objective of the present invention is to provide a compounded phosphorus-nitrogen-based flame-retardant regenerated cellulose fiber, wherein components of the regenerated cellulose fiber comprise cellulose and a flame retardant dispersed in a cellulose fiber matrix, and the flame retardant is the compounded phosphorus-nitrogen-based flame retardant as described above.

In a further solution, in the regenerated cellulose fiber, a mass ratio of the flame retardant to the cellulose is (15-50):100; preferably, the mass ratio is (15-35):100; more preferably (15-30):100.

Said compounded phosphorus-nitrogen-based flame retardant comprises a compounded mixture of a phosphoramide ester compound and an inorganic compound, wherein a mass ratio of said phosphoramide ester compound and said inorganic compound is (10-35):(0.1-10).

Preferably, the mass ratio of said phosphoramide ester compound and said inorganic compound is (10-30):(0.1-10).

More preferably, the mass ratio of said phosphoramide ester compound and said inorganic compound is (10-25):(0.1-10).

In the compounded phosphorus-nitrogen-based flame retardant system of the present invention, the phosphoramide ester compound belongs to a high-efficiency flame retardant, which can achieve a high-efficiency effect with a small amount, therefore, a flame retardant effect of the fiber is mainly determined by the phosphonamide ester compound, and the inorganic compound is mainly used as a synergistic flame retardant aid, and a small amount of addition can play a role in inhibiting smoke release and reinforcing. Under a range of a total amount of flame retardant added in the present invention (15-50%), using the inorganic compound alone cannot produce a fiber with excellent flame retardant effect and mechanical properties, for example, for montmorillonite, an addition amount of at least 55% is required to achieve an effect of self-extinguishing after leaving a fire, but at this time, the mechanical properties of the fiber are lost by at least 50%, which cannot meet use requirements, and if the total amount of flame retardant added is fixed, increasing the mass of the inorganic compound will affect the flame retardant performance of the fiber, and more inorganic compounds also have a greater impact on the mechanical properties of the fiber. It is found through experiments that when the mass ratio of the phosphoramide ester compound to the inorganic compound is controlled to be (10-35):(0.1-10), the synergistic effect of the compounded flame retardant and smoke suppression is better, and the fiber properties are better.

In a further solution, said regenerated cellulose fibers have a dry breaking strength of ≥2.0 cN/dtex, a wet breaking strength of ≥1.5 cN/dtex, and a limiting oxygen index value of ≥28%.

In a further solution, the regenerated cellulose fiber can be a filament, a staple fiber or a tow, and can be used for a woven fabric, a knitted fabric, a non-woven fabric or blended with other fibers.

The fourth objective of the present invention is to provide a preparation method of compounded phosphorus-nitrogen-based flame-retardant regenerated cellulose fibers, comprising:
(1) Preparing a slurry of a compounded phosphorus-nitrogen-based flame retardant by using the preparation method as described above;
(2) Mixing the obtained slurry of the compounded phosphorus-nitrogen-based flame retardant with a suspension of cellulose or a cellulose solution, and dispersing uniformly to prepare a flame-retardant cellulose spinning solution, which is extruded through a spinneret into a coagulation bath for forming, followed by stretching, washing, oiling, and drying to obtain the compounded phosphorus-nitrogen-based flame-retardant regenerated cellulose fibers.

The compounded phosphorus-nitrogen-based flame retardant system provided by the present invention can be uniformly dispersed in a spinning solution, which ensures that the flame retardant can effectively penetrate into an interior of a fiber, improves a washing resistance of the fiber, and finally prepares a flame-retardant regenerated cellulose fiber with excellent durability and flame retardant performance. The prepared compounded phosphorus-nitrogen-based flame-retardant regenerated cellulose fiber has excellent mechanical properties, and excellent flame retardant performance and smoke suppression performance.

In a further solution, in step (2), the cellulose solution comprises a cellulose xanthate solution, a solution of cellulose in N-methylmorpholine-N-oxide, a solution of cellulose in an ammonia solution of copper hydroxide or copper salt, or a solution of cellulose in an ionic liquid.

In a further solution, components of said coagulation bath comprise sulfuric acid, sodium sulfate, zinc sulfate; or, said coagulation bath is an NMMO aqueous solution.

After the above technical solution is used, the present invention has the following beneficial effects compared with the prior art.
(1) The compounded phosphorus-nitrogen-based flame retardant system provided by the present invention is environmentally friendly, highly efficient, requires a small addition amount, has good smoke suppression properties, and possesses broad application prospects. Specifically, the compounded phosphorus-nitrogen-based flame retardant provided by the present invention is a mixture of phosphoramide ester compounds and inorganic compounds, with the following benefits: the organic-inorganic compounded system can achieve an effective synergistic flame retardant effect, utilizing both the advantages of high-efficiency flame retardancy of phosphoric amide ester compounds and the characteristics of inorganic compounds such as low cost, non-toxic smoke suppression, and promotion of carbonization. Under the condition of ensuring a relatively small addition amount of flame retardant, it can achieve good flame retardant effects, with good fiber mechanical properties and low smoke density during combustion.
(2) The present invention uses inorganic compounds as synergistic flame retardant additives, with the benefits of: Inorganic compounds more easily achieving nanoscale particle size and readily form porous structures in the fiber, thus providing a good reinforcing effect, reducing the impact of flame retardant addition on the mechanical properties of the fiber.
(3) The present invention adopts a graded grinding method, i.e., first grinding the phosphoramide ester compounds to a certain particle size, then adding inorganic compounds and grinding to the required particle size. This not only improves the emulsification and uniform dispersion of the dispersion system but also ensures the uniform distribution of particle sizes of different flame retardant components in the flame retardant slurry, solving the technical problems of difficulty in direct blending of flame retardants with the spinning solution and poor filterability and spinnability of the spinning solution in the prior art.
(4) The present invention modifies the flame retardant system during the grinding process, effectively improving the hydrophobicity of the flame retardant system and its compatibility with cellulose macromolecules, thereby ensuring the durability of the flame-retardant regenerated cellulose fiber.
(5) The phosphoramide ester compounds provided by the present invention, after pretreatment and modification, form a stable protective film on the surface of the flame retardant particles due to the hydrolysis reaction of the modifying agent, effectively improving the hydrophobicity of the phosphoramide ester compounds, avoiding the migration and leaching of flame retardants during use and washing, and ensuring the water resistance and acid-alkali resistance of the flame-retardant fibers.
(6) The compounded phosphorus-nitrogen-based flame retardant system provided by the present invention can be uniformly dispersed in a spinning solution, which ensures that the flame retardant can effectively penetrate into an interior of a fiber, improves a washing resistance of the fiber, and finally prepares a flame-retardant regenerated cellulose fiber with excellent durability and flame retardant performance.
(7) The compounded phosphorus-nitrogen-based flame-retardant regenerated cellulose fiber prepared by the present invention has excellent mechanical properties, as well as excellent flame retardant and smoke suppression properties, well balancing the flame retardant properties and mechanical properties of flame retardant fibers, with good flame retardant durability.

### DETAILED DESCRIPTION

In order to make the purposes, technical solutions and advantages of the embodiments of the present invention clearer, the technical solutions in the embodiments of the present invention will be clearly and completely described below with reference to the embodiments of the present invention. The following embodiments are used to illustrate the present invention, but not to limit the scope of the present invention.

### Embodiment 1

A compounded phosphorus-nitrogen-based flame-retardant regenerated cellulose fiber and preparation method thereof, comprising the following process steps:
(1) Preparation of flame retardant slurry:

Prepare 0.5 parts of zinc oxide, 1 part of kaolin, 1 part of sodium polyacrylate, 0.2 parts of sodium allyl sulfonate, 0.3 parts of sodium hexametaphosphate; separately add sodium polyacrylate, sodium allyl sulfonate, and sodium hexametaphosphate to deionized water and mix uniformly, then add 10 parts of 1,2-bis(2-oxo-4-methoxy-5,5-dimethyl-1,3,2-dioxaphosphorinan-2-amino) ethane, uniformly disperse by mechanical stirring for 0.5 h, then grind at 20° C. with a grinding speed of 1300 rpm, so that the flame retardant particles have a particle size distribution of X10 less than 1 μm and X90 less than 10 μm; subsequently, slowly add zinc oxide and kaolin, as well as 10 parts of ethanol solution of dimethyldiethoxysilane, where the molar concentration of dimethyldiethoxysilane in the ethanol solution is 0.02 mol/L, continue grinding until the flame retardant particles in the compounded flame retardant slurry have a particle size distribution of X10 less than 0.5 μm and X90 less than 1.0 μm, with a solid content of the flame retardant in the slurry being 20%.
(2) Preparation of flame-retardant viscose fiber:

Add the obtained compounded flame retardant slurry to a viscose solution with an alpha-cellulose content of 7%, sodium hydroxide content of 5.8%, viscosity of 45s, and ripeness of 16 ml (calculated by 10% NH₄Cl), rapidly stir at 30° C. to prepare a uniform flame retardant viscose spinning solution, with the flame retardant content being 18% of the cellulose weight. Degas and filter the spinning solution, then extrude it through a spinneret into a coagulation bath for forming, followed by stretching, washing, oiling, and drying to obtain compounded phosphorus-nitrogen-based flame-retardant viscose fiber. The composition of said coagulation bath is 100 g/L sulfuric acid, 240 g/L sodium sulfate, 52 g/L zinc sulfate, and the temperature of the coagulation bath is 55° C. The fiber indicators are shown in Table 1.

### Embodiment 2

(1) Preparation of flame retardant slurry:

Prepare 0.5 parts of boron nitride, 0.2 parts of fatty alcohol polyoxyethylene ether sulfate sodium, 0.3 parts of sodium dodecyl sulfate; separately add fatty alcohol polyoxyethylene ether sulfate sodium and sodium dodecyl sulfate to deionized water and mix uniformly, then add 10 parts of 1,2-bis(2-oxo-5,5-dimethyl-1,3,2-dioxaphosphorinan-2-amino)benzoic acid, uniformly disperse by ultrasonic dispersion for 0.5 h, then grind at 25° C. with a grinding speed of 1200 rpm, so that the flame retardant particles have a particle size distribution of X10 less than 1 μm and X90 less than 10 μm; subsequently, slowly add boron nitride, as well as 5 parts of ethanol solution of 3-aminopropyltrimethoxysilane, where the molar concentration of 3-aminopropyltrimethoxysilane in the ethanol solution is 0.1 mol/L, continue grinding until the flame retardant particles in the composite flame retardant slurry have a particle size distribution of X10 less than 0.5 μm and X90 less than 2.0 μm, with a solid content of the flame retardant in the slurry being 25%.
(2) Preparation of flame-retardant viscose fiber:

Add the obtained compounded flame retardant slurry to a viscose solution with an alpha-cellulose content of 8.2%, sodium hydroxide content of 6.5%, viscosity of 42s, and ripeness of 15 ml (calculated by 10% NH₄Cl), rapidly stir at 30° C. to prepare a uniform flame retardant viscose spinning solution, with the flame retardant content being 30% of the cellulose weight. Degas and filter the spinning solution, then extrude it through a spinneret into a coagulation bath for forming, followed by stretching, washing, oiling, and drying to obtain compounded phosphorus-nitrogen-based flame-retardant viscose fiber. The composition of said coagulation bath is 120 g/L sulfuric acid, 260 g/L sodium sulfate, 60 g/L zinc sulfate, and the temperature of the coagulation bath is 60° C. The fiber indicators are shown in Table 1.

### Embodiment 3

A compounded phosphorus-nitrogen-based flame-retardant regenerated cellulose fiber and preparation method thereof, comprising the following process steps:
(1) Flame retardant pretreatment:

Uniformly disperse 10 parts of 1,2-bis(2-thio-5,5-dimethyl-1,3,2-dioxaphosphorinane-2-amino) ethane in 100 parts of a mixed solution of ethanol and water, wherein the mixed solution comprises 65 parts of ethanol and 35 parts of water, and add acetic acid to adjust the pH of the mixed solution to 5-6. Then, add 20 parts of tetraethyl orthosilicate, and after reaction at room temperature for 4 h, add 5 parts of stearic acid and process at 50° C. for 5 h, followed by filtering, washing, and drying to obtain modified 1,2-bis(2-thio-5,5-dimethyl-1,3,2-dioxaphosphorinane-2-amino) ethane.
(2) Preparation of flame retardant slurry:

Prepare 5 parts of sodium silicate, 0.5 parts of sodium fatty alcohol polyoxyethylene ether carboxylate, 0.3 parts of sodium dodecylbenzene sulfonate, 2 parts of polydimethylsiloxane; add sodium fatty alcohol polyoxyethylene ether carboxylate, sodium dodecylbenzene sulfonate, and polydimethylsiloxane to deionized water and mix until uniformly dispersed, then add 10 parts of modified 1,2-bis(2-thio-5,5-dimethyl-1,3,2-dioxaphosphorinane-2-amino) ethane. After uniform dispersion by mechanical stirring for 1 h, grind at 40° C. with a grinding speed of 1000 rpm, such that the flame retardant particles have a particle size distribution with X10 less than 1 μm and X90 less than 10 μm; then slowly add sodium silicate, and 10 parts of stearic acid ethanol solution, where the concentration of stearic acid in the ethanol solution is 0.1 mol/L, continue grinding until the flame retardant particles in the compounded flame retardant slurry have a particle size distribution with X50 less than 0.1 μm and X90 less than 3.0 μm, with a solid content of the flame retardant in the slurry being 25%.
(3) Preparation of flame-retardant viscose fiber:

Add the obtained compounded flame retardant slurry to a viscose solution with an alpha-cellulose content of 8.5%, sodium hydroxide content of 6.3%, viscosity of 40s, and ripeness of 14 ml (calculated by 10% NH₄Cl), rapidly stir at 30° C. to prepare a uniform flame retardant viscose spinning solution, with the flame retardant content being 18% of the cellulose weight. Degas and filter the spinning solution, then extrude it through a spinneret into a coagulation bath for forming, followed by stretching, washing, oiling, and drying to obtain compounded phosphorus-nitrogen-based flame-retardant viscose fiber. The composition of said coagulation bath is 100 g/L sulfuric acid, 220 g/L sodium sulfate, 30 g/L zinc sulfate, and the temperature of the coagulation bath is 45° C. The fiber indicators are shown in Table 1.

### Embodiment 4

A compounded phosphorus-nitrogen-based flame-retardant regenerated cellulose fiber and preparation method thereof, comprising the following process steps:
(1) Flame retardant pretreatment:

Uniformly disperse 10 parts of 1,3-bis(2-oxo-5,5-dimethyl-1,3,2-dioxaphosphorinane-2-amino) hydroxypropane in 100 parts of a mixed solution of ethanol and water, wherein the mixed solution comprises 50 parts of ethanol and 50 parts of water, and add sodium carbonate to adjust the pH of the mixed solution to 9-10. Then, add 5 parts of tetraethyl orthosilicate, and after reacting at room temperature for 4 h, add 3 parts of dodecyl mercaptan, followed by treatment at 50° C. for 5 h, followed by filtering, washing, and drying to obtain modified 1,3-bis(2-oxo-5,5-dimethyl-1,3,2-dioxaphosphorinane-2-amino) hydroxypropane.
(2) Preparation of flame retardant slurry:

Prepare 0.5 part of silicon dioxide, 1 part of magnesium hydroxide, 0.2 part of fatty alcohol ether sulfate sodium, 0.2 part of styrene-maleic anhydride, 0.1 part of sodium hexametaphosphate; separately add fatty alcohol ether sulfate sodium and styrene-maleic anhydride, sodium tripolyphosphate to deionized water and mix uniformly, then add 10 parts of modified 1,3-bis(2-oxo-5,5-dimethyl-1,3,2-dioxaphosphinane-2-amino) hydroxypropane, use mechanical stirring to uniformly disperse for 1 h and then grind at 25° C., with a grinding speed of 1100 rpm, so that the flame retardant particles have a particle size distribution of X10 less than 1 μm and X99 less than 10 μm; subsequently slowly add silicon dioxide and magnesium hydroxide, as well as 8 parts of dodecyl mercaptan ethanol solution, wherein the molar concentration of dodecyl mercaptan in the ethanol solution is 0.05 mol/L, continue grinding until the flame retardant particles in the compounded flame retardant slurry have a particle size distribution of X10 less than 0.5 μm and X90 less than 1.0 μm, with a solid content of the flame retardant in the slurry being 20%.
(3) Preparation of flame-retardant viscose fiber:

Add the obtained compounded flame retardant slurry to a viscose solution with an alpha-cellulose content of 6.2%, sodium hydroxide content of 6.0%, viscosity of 48 s, and ripeness of 25 ml (calculated by 10% NH₄Cl), rapidly stir at 25° C. to prepare a uniform flame retardant viscose spinning solution, with the flame retardant content being 22% of the cellulose weight. Degas and filter the spinning solution, then extrude it through a spinneret into a coagulation bath for forming, followed by stretching, washing, oiling, and drying to obtain compounded phosphorus-nitrogen-based flame-retardant viscose fiber. The composition of said coagulation bath is 90 g/L sulfuric acid, 180 g/L sodium sulfate, 35 g/L zinc sulfate, and the temperature of the coagulation bath is 65° C. The fiber indicators are shown in Table 1.

### Embodiment 5

A compounded phosphorus-nitrogen-based flame-retardant regenerated cellulose fiber and preparation method thereof, comprising the following process steps:
(1) Preparation of flame retardant slurry:

Prepare 3 parts of magnesium hydroxide, 2 parts of aluminum hydroxide, 0.3 parts of sodium methylene bis-naphthalenesulfonate, 0.2 parts of a styrene-acrylic acid modified copolymer, 0.1 parts of a fatty alcohol polyoxyethylene ether phosphate, and 3 parts of polydimethylsiloxane. Add the sodium methylene bis-naphthalenesulfonate, the styrene-acrylic acid modified copolymer, the fatty alcohol polyoxyethylene ether phosphate, and the polydimethylsiloxane to deionized water separately and mix uniformly. Then, add 10 parts of 1,2-bis(2-thio-5,5-dimethyl-1,3,2-dioxaphosphorinan-2-amino) ethane, uniformly disperse them by mechanical stirring for 1 h, and grind at 25° C. at a grinding speed of 1300 rpm, such that flame retardant particles have a particle size distribution of X10 less than 1 μm and X90 less than 10 μm. Subsequently, slowly add the magnesium hydroxide and the aluminum hydroxide, as well as 10 parts of an ethanol solution of vinyltrimethoxysilane, wherein a concentration of the vinyltrimethoxysilane in the ethanol solution is 0.1 mol/L, and continue grinding until the flame retardant particles in the compounded flame retardant slurry have a particle size distribution of X10 less than 0.5 μm and X90 less than 2.0 μm, with a solid content of the flame retardant in the slurry being 15%.
(2) Preparation of a flame-retardant Lyocell fiber:

Uniformly mix the compounded flame retardant slurry obtained in step (1) with an NMMO aqueous solution having a mass concentration of 80%, and then add wood pulp with a degree of polymerization of 620 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 9.2 KPa; the dissolution and dehydration temperature is 105° C., and the dehydration pressure is 6.0 KPa; the viscosity of the spinning solution is 18000 poise, the content of the flame retardant is 25 wt % of the weight of the cellulose, and the content of the cellulose is 9.5 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 22% NMMO aqueous solution, and the coagulation temperature is 20° C. The fiber indicators are shown in Table 1.

### Embodiment 6

A compounded phosphorus-nitrogen-based flame-retardant regenerated cellulose fiber and preparation method thereof, comprising the following process steps:
(1) Preparation of flame retardant slurry:

Prepare 2 parts of zinc borate, 0.3 parts of sodium alpha-olefin sulfonate, 0.1 parts of sodium hexametaphosphate, 0.3 parts of an EO/PO block copolymer, and 2 parts of polydimethylsiloxane. Add the sodium alpha-olefin sulfonate, the sodium hexametaphosphate, the EO/PO block copolymer, and the polydimethylsiloxane to 60% NMMO separately and mix uniformly. Then, add 10 parts of 1,2-bis(2-oxo-5,5-dimethyl-1,3,2-dioxaphosphorinan-2-amino)benzoic acid, uniformly disperse them by mechanical stirring for 4 h, and then grind at 30° C. at a grinding speed of 1200 rpm, such that flame retardant particles have a particle size distribution of X10 less than 1 μm and X90 less than 10 μm. Subsequently, slowly add the zinc borate, as well as 10 parts of an ethanol solution of vinyltriethoxysilane, wherein a concentration of the vinyltriethoxysilane in the ethanol solution is 0.1 mol/L, and continue grinding until the flame retardant particles in a compounded flame retardant slurry have a particle size distribution of X10 less than 0.5 μm and X90 less than 1.0 μm, with a solid content of the flame retardant in the slurry being 18%.
(2) Preparation of a flame-retardant Lyocell fiber:

Uniformly mix the compounded flame retardant slurry obtained in step (1) with an NMMO aqueous solution having a mass concentration of 75%, and then add wood pulp with a degree of polymerization of 650 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 85° C., and the dehydration pressure is 9.5 KPa; the dissolution and dehydration temperature is 100° C., and the dehydration pressure is 5.8 KPa; the viscosity of the spinning solution is 10000 poise, the content of the flame retardant is 18 wt % of the weight of the cellulose, and the content of the cellulose is 9 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 25% NMMO aqueous solution, and the coagulation temperature is 20° C. The fiber indicators are shown in Table 1.

### Embodiment 7

A compounded phosphorus-nitrogen-based flame-retardant regenerated cellulose fiber and preparation method thereof, comprising the following process steps:
(1) Flame retardant pretreatment:

Uniformly disperse 10 parts of 1,2-bis(2-oxo-5,5-dimethyl-1,3,2-dioxaphosphorinan-2-amino) ethane in 100 parts of a mixed solution of ethanol and water, wherein the mixed solution contains 80 parts of ethanol and 20 parts of water, and add ammonia water to adjust a pH of the mixed solution to 9-10. Then, add 5 parts of tetraethyl orthosilicate, and after reacting at room temperature for 4 h, add 3 parts of y-aminopropyltriethoxysilane and process at 60° C. for 5 h, followed by filtering, washing, and drying to obtain modified 1,2-bis(2-oxo-5,5-dimethyl-1,3,2-dioxaphosphorinan-2-amino) ethane.
(2) Preparation of flame retardant slurry:

Prepare 5 parts of montmorillonite, 0.8 parts of sodium polyacrylate, 1 part of sodium dodecyl sulfate, and 1 part of styrene-maleic anhydride. Add the sodium polyacrylate, the sodium dodecyl sulfate, and the styrene-maleic anhydride to 50% NMMO separately and mix uniformly. Then, add 10 parts of modified 1,2-bis(2-oxo-5,5-dimethyl-1,3,2-dioxaphosphorinan-2-amino) ethane, uniformly disperse them by mechanical stirring for 3 h, and grind at 30° C. at a grinding speed of 1400 rpm, such that flame retardant particles have a particle size distribution of X10 less than 1 μm and X90 less than 10 μm. Subsequently, slowly add the montmorillonite, as well as 5 parts of an ethanol solution of y-aminopropyltriethoxysilane, wherein a concentration of stearic acid in the ethanol solution is 0.1 mol/L, and continue grinding until the flame retardant particles in a compounded flame retardant slurry have a particle size distribution of X10 less than 0.5 μm and X90 less than 2.0 μm, with a solid content of the flame retardant in the slurry being 15%.
(3) Preparation of a flame-retardant Lyocell fiber:

Uniformly mix the compounded flame retardant slurry obtained in step (2) with an NMMO aqueous solution having a mass concentration of 82%, and then add wood pulp with a degree of polymerization of 620 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 92° C., and the dehydration pressure is 12.8 KPa; the dissolution and dehydration temperature is 108° C., and the dehydration pressure is 7.5 KPa; the viscosity of the spinning solution is 22000 poise, the content of the flame retardant is 25 wt % of the weight of the cellulose, and the content of the cellulose is 10 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 22% NMMO aqueous solution, and the coagulation temperature is 20° C. The fiber indicators are shown in Table 1.

### Embodiment 8

A compounded phosphorus-nitrogen-based flame-retardant regenerated cellulose fiber and preparation method thereof, comprising the following process steps:
(1) Flame retardant pretreatment:

Uniformly disperse 10 parts of 1,4-bis(2-oxo-4-methoxy-5,5-dimethyl-1,3,2-dioxaphosphorinan-2-amino) piperazine in 100 parts of a mixed solution of ethanol and water, wherein the mixed solution contains 75 parts of ethanol and 25 parts of water, and add ammonia water to adjust a pH of the mixed solution to 9-10. Then, add 5 parts of tetrabutyl orthosilicate, and after reacting at room temperature for 4 h, add 5 parts of y-(2,3-epoxypropoxy) propyltrimethoxysilane and process at 50° C. for 6 h, followed by filtering, washing, and drying to obtain modified 1,4-bis(2-oxo-5,5-dimethyl-1,3,2-dioxaphosphorinan-2-amino) piperazine.
(2) Preparation of flame retardant slurry:

Prepare 1 part of silicon dioxide, 0.2 parts of a naphthalenesulfonate salt, 0.2 parts of sodium dodecylbenzenesulfonate, and 0.1 parts of sodium hexametaphosphate. Add the naphthalenesulfonate salt, the sodium dodecylbenzenesulfonate, and the sodium hexametaphosphate to 55% NMMO separately and mix uniformly. Then, add 10 parts of modified 1,4-bis(2-oxo-4-methoxy-5,5-dimethyl-1,3,2-dioxaphosphorinan-2-amino) piperazine, uniformly disperse them by mechanical stirring for 0.5 h, and grind at 20° C. at a grinding speed of 1400 rpm, such that flame retardant particles have a particle size distribution of X10 less than 1 μm and X90 less than 10 μm. Subsequently, slowly add the silicon dioxide, as well as 2 parts of an ethanol solution of Y-(2,3-epoxypropoxy) propyltrimethoxysilane, wherein a concentration of the Y-(2,3-epoxypropoxy) propyltrimethoxysilane in the ethanol solution is 0.05 mol/L, and continue grinding until the flame retardant particles in a compounded flame retardant slurry have a particle size distribution of X10 less than 0.5 μm and X90 less than 3.0 μm, with a solid content of the flame retardant in the slurry being 15%.
(3) Preparation of a flame-retardant regenerated cellulose fiber:

Uniformly mix the compounded flame retardant slurry obtained in step (2) with an NMMO aqueous solution having a mass concentration of 70%, and then add wood pulp with a degree of polymerization of 650 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 11.5 KPa; the dissolution and dehydration temperature is 102° C., and the dehydration pressure is 5.2 KPa; the viscosity of the spinning solution is 25000 poise, the content of the flame retardant is 22 wt % of the weight of the cellulose, and the content of the cellulose is 11 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 15% NMMO aqueous solution, and the coagulation temperature is 20° C. The fiber indicators are shown in Table 1.

### Comparative Example 1

A phosphorus-nitrogen-based flame-retardant regenerated cellulose fiber and preparation method thereof, comprising the following process steps:
(1) Preparation of flame retardant slurry:

Prepare 0.3 parts of sodium fatty alcohol polyoxyethylene ether carboxylate, 0.2 parts of sodium dodecylbenzenesulfonate, 0.2 parts of sodium pyrophosphate, and 1 part of polydimethylsiloxane. Add the sodium fatty alcohol polyoxyethylene ether carboxylate, the sodium dodecylbenzenesulfonate, the sodium pyrophosphate, and the polydimethylsiloxane to deionized water and mix until uniformly dispersed, then add 10 parts of 1,2-bis(2-thio-5,5-dimethyl-1,3,2-dioxaphosphorinan-2-amino) ethane. Uniformly disperse the mixture by mechanical stirring for 1 h and then grind at 25° C. at a grinding speed of 1000 rpm, such that flame retardant particles have a particle size distribution of X10 less than 0.5 μm and X90 less than 3.0 μm, with a solid content of the flame retardant in the slurry being 25%.
(2) Preparation of a flame-retardant regenerated cellulose fiber:

Add the obtained compounded flame retardant slurry to a viscose solution with an alpha-cellulose content of 8.2%, sodium hydroxide content of 6.0%, viscosity of 43s, and ripeness of 18 ml (calculated by 10% NH₄Cl), rapidly stir at 25° C. to prepare a uniform flame retardant viscose spinning solution, with the flame retardant content being 18% of the cellulose weight. Degas and filter the spinning solution, then extrude it through a spinneret into a coagulation bath for forming, followed by stretching, washing, oiling, and drying to obtain compounded phosphorus-nitrogen-based flame-retardant viscose fiber. The composition of said coagulation bath is 100 g/L sulfuric acid, 220 g/L sodium sulfate, 30 g/L zinc sulfate, and the temperature of the coagulation bath is 45° C. The fiber indicators are shown in Table 1.

### Comparative Example 2

A phosphorus-nitrogen-based flame-retardant regenerated cellulose fiber and preparation method thereof, comprising the following process steps:
(1) Preparation of flame retardant slurry:

Prepare 0.2 parts of sodium fatty alcohol ether sulfate, 0.2 parts of styrene-maleic anhydride, and 0.1 parts of sodium tripolyphosphate. Add the sodium fatty alcohol ether sulfate, the styrene-maleic anhydride, and the sodium tripolyphosphate to deionized water separately and mix uniformly. Then, add 10 parts of 1,3-bis(2-oxo-5,5-dimethyl-1,3,2-dioxaphosphorinan-2-amino) hydroxypropane, uniformly disperse them by mechanical stirring for 1 h, and grind at 25° C. at a grinding speed of 1100 rpm, such that flame retardant particles have a particle size distribution of X10 less than 0.5 μm and X90 less than 1.0 μm, with a solid content of the flame retardant in the slurry being 20%.
(2) Preparation of a flame-retardant regenerated cellulose fiber:

Add the obtained compounded flame retardant slurry to a viscose solution with an alpha-cellulose content of 6.5%, sodium hydroxide content of 6.2%, viscosity of 46s, and ripeness of 28 ml (calculated by 10% NH₄Cl), rapidly stir at 25° C. to prepare a uniform flame retardant viscose spinning solution, with the flame retardant content being 22% of the cellulose weight. Degas and filter the spinning solution, then extrude it through a spinneret into a coagulation bath for forming, followed by stretching, washing, oiling, and drying to obtain compounded phosphorus-nitrogen-based flame-retardant viscose fiber. The composition of said coagulation bath is 90 g/L sulfuric acid, 180 g/L sodium sulfate, 35 g/L zinc sulfate, and the temperature of the coagulation bath is 65° C. The fiber indicators are shown in Table 1.

### Comparative Example 3

A production process for an ordinary regenerated cellulose fiber, comprising the following specific steps:

Degas and filter a viscose solution having an alpha-cellulose content of 7%, a sodium hydroxide content of 5.8%, a viscosity of 45 s, and a ripening degree of 16 ml (based on 10% NH₄Cl), then extrude it through a spinneret into a coagulation bath for forming, followed by drawing, washing, oiling, and drying to obtain a viscose fiber. The composition of said coagulation bath is 100 g/L sulfuric acid, 240 g/L sodium sulfate, 52 g/L zinc sulfate, and the temperature of the coagulation bath is 55° C. The fiber indicators are shown in Table 1.

### Comparative Example 4

A phosphorus-nitrogen-based flame-retardant regenerated cellulose fiber and preparation method thereof, comprising the following process steps:
(1) Preparation of flame retardant slurry:

Prepare 0.2 parts of a naphthalenesulfonate salt, 0.2 parts of sodium dodecylbenzenesulfonate, and 0.1 parts of sodium hexametaphosphate. Add the naphthalenesulfonate salt, the sodium dodecylbenzenesulfonate, and the sodium hexametaphosphate to 50% NMMO separately and mix uniformly. Then, add 10 parts of 1,2-bis(2-oxo-5,5-dimethyl-1,3,2-dioxaphosphorinan-2-amino)benzoic acid, uniformly disperse them by mechanical stirring for 3 h, and grind at 10° C. at a grinding speed of 1300 rpm until flame retardant particles have a particle size distribution of X10 less than 0.5 μm and X90 less than 5.0 μm.
(2) Preparation of a flame-retardant regenerated cellulose fiber:

Uniformly mix the compounded flame retardant slurry obtained in step (1) with an NMMO aqueous solution having a mass concentration of 68%, and then add wood pulp with a degree of polymerization of 650 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 11.5 KPa; the dissolution and dehydration temperature is 102° C., and the dehydration pressure is 5.2 KPa; the viscosity of the spinning solution is 16000 poise, the content of the flame retardant is 18 wt % of the weight of the cellulose, and the content of the cellulose is 9 wt % of the weight of the spinning solution. Degas and filter the obtained spinning solution, followed by dry-jet wet spinning, washing, oiling, and drying to obtain a phosphorus-nitrogen-based flame-retardant Lyocell fiber; the obtained fiber properties are shown in Table 1.

### Comparative Example 5

A phosphorus-nitrogen-based flame-retardant regenerated cellulose fiber and preparation method thereof, comprising the following process steps:
(1) Preparation of flame retardant slurry:

Prepare 0.3 parts of sodium fatty alcohol polyoxyethylene ether carboxylate and 0.2 parts of sodium dodecylbenzenesulfonate. Add the sodium fatty alcohol polyoxyethylene ether carboxylate and the sodium dodecylbenzenesulfonate to deionized water separately and mix uniformly. Then, add 10 parts of 1,2-bis(2-thio-5,5-dimethyl-1,3,2-dioxaphosphorinan-2-amino) ethane, uniformly disperse them by mechanical stirring for 2 h, and grind at 20° C. at a grinding speed of 1300 rpm, such that flame retardant particles have a particle size distribution of X10 less than 0.5 μm and X90 less than 5.0 μm.
(2) Preparation of a flame-retardant regenerated cellulose fiber:

Uniformly mix the compounded flame retardant slurry obtained in step (1) with an NMMO aqueous solution having a mass concentration of 78%, and then add wood pulp with a degree of polymerization of 500 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 9.8 KPa; the dissolution and dehydration temperature is 105° C., and the dehydration pressure is 8.5 KPa; the viscosity of the spinning solution is 18000 poise, the content of the flame retardant is 25 wt % of the weight of the cellulose, and the content of the cellulose is 10 wt % of the weight of the spinning solution. Degas and filter the obtained spinning solution, followed by dry-jet wet spinning, washing, oiling, and drying to obtain a phosphorus-nitrogen-based flame-retardant Lyocell fiber; the obtained fiber properties are shown in Table 1.

### Comparative Example 6

A production process for an ordinary regenerated cellulose fiber, in which wood pulp with a degree of polymerization of 720 is selected as a raw material, comprising the following specific steps:

Uniformly mix the cellulose pulp with an NMMO solvent having a mass concentration of 78% to form a suspension of a cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 10 KPa; the dissolution and dehydration temperature is 105° C., and the dehydration pressure is 7 KPa; the viscosity of the spinning solution is 25000 poise, and the content of the cellulose is 11 wt % of the weight of the spinning solution. Filter and degas the above spinning solution, followed by dry-jet wet spinning to obtain a Lyocell fiber. The fiber indicators are shown in Table 1.

For the test results of the above properties, see Table 1.

### Comparative Example 7

A flame-retardant regenerated cellulose fiber and preparation method thereof, comprising the following process steps:
(1) Preparation of flame retardant slurry:

Prepare 5 parts of montmorillonite, 0.8 parts of sodium polyacrylate, 1 part of sodium dodecyl sulfate, and 1 part of styrene-maleic anhydride. Add the sodium polyacrylate, the sodium dodecyl sulfate, and the styrene-maleic anhydride to 50% NMMO separately and mix uniformly. Then, add the montmorillonite, uniformly disperse it by mechanical stirring for 3 h, and grind at 30° C. at a grinding speed of 1400 rpm, such that montmorillonite particles in a flame retardant slurry have a particle size distribution of X10 less than 0.5 μm and X90 less than 2.0 μm, with a solid content of the montmorillonite in the slurry being 15%.
(2) Preparation of a flame-retardant Lyocell fiber:

Uniformly mix the flame retardant slurry obtained in step (1) with an NMMO aqueous solution having a mass concentration of 82%, and then add wood pulp with a degree of polymerization of 620 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 92° C., and the dehydration pressure is 12.8 KPa; the dissolution and dehydration temperature is 108° C., and the dehydration pressure is 7.5 KPa; the viscosity of the spinning solution is 22000 poise, the content of the flame retardant is 25 wt % of the weight of the cellulose, and the content of the cellulose is 10 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 22% NMMO aqueous solution, and the coagulation temperature is 20° C. The fiber indicators are shown in Table 1.

### Comparative Example 8

A flame-retardant regenerated cellulose fiber and preparation method thereof, comprising the following process steps:
(1) Flame retardant pretreatment:

Uniformly disperse 10 parts of 1,2-bis(2-thio-5,5-dimethyl-1,3,2-dioxaphosphorinane-2-amino) ethane in 100 parts of a mixed solution of ethanol and water, wherein the mixed solution comprises 65 parts of ethanol and 35 parts of water, and add acetic acid to adjust the pH of the mixed solution to 5-6. Then, add 20 parts of tetraethyl orthosilicate, and after reaction at room temperature for 4 h, add 5 parts of stearic acid and process at 50° C. for 5 h, followed by filtering, washing, and drying to obtain modified 1,2-bis(2-thio-5,5-dimethyl-1,3,2-dioxaphosphorinane-2-amino) ethane.
(2) Preparation of flame retardant slurry:

Prepare 0.5 parts of sodium fatty alcohol polyoxyethylene ether carboxylate, 0.3 parts of sodium dodecylbenzene sulfonate, 2 parts of polydimethylsiloxane; add sodium fatty alcohol polyoxyethylene ether carboxylate, sodium dodecylbenzene sulfonate, and polydimethylsiloxane to deionized water and mix until uniformly dispersed, then add 10 parts of modified 1,2-bis(2-thio-5,5-dimethyl-1,3,2-dioxaphosphorinane-2-amino) ethane. After uniform dispersion by mechanical stirring for 1 h, grind at 40° C. with a grinding speed of 1000 rpm, such that the flame retardant particles have a particle size distribution with X10 less than 1 μm and X90 less than 10 μm; then slowly add 10 parts of stearic acid ethanol solution, where the concentration of stearic acid in the ethanol solution is 0.1 mol/L, continue grinding until the flame retardant particles in the flame retardant slurry have a particle size distribution with X50 less than 0.1 μm and X90 less than 3.0 μm, with a solid content of the flame retardant in the slurry being 25%.
(3) Preparation of flame-retardant viscose fiber:

Add the obtained flame retardant slurry to a viscose solution with an alpha-cellulose content of 8.5%, sodium hydroxide content of 6.3%, viscosity of 40s, and ripeness of 14 ml (calculated by 10% NH₄Cl), rapidly stir at 30° C. to prepare a uniform flame retardant viscose spinning solution, with the flame retardant content being 18% of the cellulose weight. Degas and filter the spinning solution, then extrude it through a spinneret into a coagulation bath for forming, followed by stretching, washing, oiling, and drying to obtain compounded phosphorus-nitrogen-based flame-retardant viscose fiber. The composition of said coagulation bath is 100 g/L sulfuric acid, 220 g/L sodium sulfate, 30 g/L zinc sulfate, and the temperature of the coagulation bath is 45° C. The fiber indicators are shown in Table 1.

### Comparative Example 9

A flame-retardant regenerated cellulose fiber and preparation method thereof, comprising the following process steps:
(1) Preparation of flame retardant slurry:

Prepare 3 parts of magnesium hydroxide, 2 parts of aluminum hydroxide, 0.3 parts of sodium naphthalene methylene disulfonate, 0.2 parts of styrene-acrylic acid modified copolymer, 0.1 parts of fatty alcohol polyoxyethylene ether phosphate, 3 parts of polydimethylsiloxane. Add the sodium naphthalene methylene disulfonate, the styrene-acrylic acid modified copolymer, the fatty alcohol polyoxyethylene ether phosphate, and the polydimethylsiloxane separately to deionized water and mix uniformly. Then, add the magnesium hydroxide and aluminum hydroxide, uniformly disperse them by mechanical stirring for 1 h, and then add 10 parts of ethanol solution of vinyltrimethoxysilane, wherein the concentration of vinyltrimethoxysilane in the ethanol solution is 0.1 mol/L. Grind at 25° C. with a grinding speed of 1300 rpm until the flame retardant particles in the flame retardant slurry have a particle size distribution with X10 less than 0.5 μm and X90 less than 2.0 μm, with a solid content of flame retardant in the slurry being 15%.
(2) Preparation of a flame-retardant Lyocell fiber:

Uniformly mix the flame retardant slurry obtained in step (1) with an NMMO aqueous solution having a mass concentration of 80%, and then add wood pulp with a degree of polymerization of 620 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 9.2 KPa; the dissolution and dehydration temperature is 105° C., and the dehydration pressure is 6.0 KPa; the viscosity of the spinning solution is 18000 poise, the content of the flame retardant is 25 wt % of the weight of the cellulose, and the content of the cellulose is 9.5 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 22% NMMO aqueous solution, and the coagulation temperature is 20° C. The fiber indicators are shown in Table 1.

### Comparative Example 10

Based on embodiment 8, adjust the mass ratio of phosphoramide ester compound and inorganic compound (silicon dioxide), specifically:

A compounded phosphorus-nitrogen-based flame-retardant regenerated cellulose fiber and preparation method thereof, comprising the following process steps:
(1) Flame retardant pretreatment:

Uniformly disperse 10 parts of 1,4-bis(2-oxo-4-methoxy-5,5-dimethyl-1,3,2-dioxaphosphorinan-2-amino) piperazine in 100 parts of a mixed solution of ethanol and water, wherein the mixed solution contains 75 parts of ethanol and 25 parts of water, and add ammonia water to adjust a pH of the mixed solution to 9-10. Then, add 5 parts of tetrabutyl orthosilicate, and after reacting at room temperature for 4 h, add 5 parts of y-(2,3-epoxypropoxy) propyltrimethoxysilane and process at 50° C. for 6 h, followed by filtering, washing, and drying to obtain modified 1,4-bis(2-oxo-5,5-dimethyl-1,3,2-dioxaphosphorinan-2-amino) piperazine.
(2) Preparation of flame retardant slurry:

Prepare 0.1 parts of silicon dioxide, 0.2 parts of a naphthalenesulfonate salt, 0.2 parts of sodium dodecylbenzenesulfonate, and 0.1 parts of sodium hexametaphosphate. Add the naphthalenesulfonate salt, the sodium dodecylbenzenesulfonate, and the sodium hexametaphosphate to 55% NMMO separately and mix uniformly. Then, add 10 parts of modified 1,4-bis(2-oxo-4-methoxy-5,5-dimethyl-1,3,2-dioxaphosphorinan-2-amino) piperazine, uniformly disperse them by mechanical stirring for 0.5 h, and grind at 20° C. at a grinding speed of 1400 rpm, such that flame retardant particles have a particle size distribution of X10 less than 1 μm and X90 less than 10 μm. Subsequently, slowly add the silicon dioxide, as well as 2 parts of an ethanol solution of γ-(2,3-epoxypropoxy) propyltrimethoxysilane, wherein a concentration of the γ-(2,3-epoxypropoxy) propyltrimethoxysilane in the ethanol solution is 0.05 mol/L, and continue grinding until the flame retardant particles in a compounded flame retardant slurry have a particle size distribution of X10 less than 0.5 μm and X90 less than 3.0 μm, with a solid content of the flame retardant in the slurry being 15%.
(3) Preparation of a flame-retardant regenerated cellulose fiber:

Uniformly mix the compounded flame retardant slurry obtained in step (2) with an NMMO aqueous solution having a mass concentration of 70%, and then add wood pulp with a degree of polymerization of 650 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 11.5 KPa; the dissolution and dehydration temperature is 102° C., and the dehydration pressure is 5.2 KPa; the viscosity of the spinning solution is 25000 poise, the content of the flame retardant is 22 wt % of the weight of the cellulose, and the content of the cellulose is 11 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 15% NMMO aqueous solution, and the coagulation temperature is 20° C. The fiber indicators are shown in Table 1.

### Comparative Example 11

Based on embodiment 8, adjust the mass ratio of phosphoramide ester compound and inorganic compound (silicon dioxide), specifically:

A compounded phosphorus-nitrogen-based flame-retardant regenerated cellulose fiber and preparation method thereof, comprising the following process steps:
(1) Flame retardant pretreatment:

Uniformly disperse 10 parts of 1,4-bis(2-oxo-4-methoxy-5,5-dimethyl-1,3,2-dioxaphosphorinan-2-amino) piperazine in 100 parts of a mixed solution of ethanol and water, wherein the mixed solution contains 75 parts of ethanol and 25 parts of water, and add ammonia water to adjust a pH of the mixed solution to 9-10. Then, add 5 parts of tetrabutyl orthosilicate, and after reacting at room temperature for 4 h, add 5 parts of γ-(2,3-epoxypropoxy) propyltrimethoxysilane and process at 50° C. for 6 h, followed by filtering, washing, and drying to obtain modified 1,4-bis(2-oxo-5,5-dimethyl-1,3,2-dioxaphosphorinan-2-amino) piperazine.
(2) Preparation of flame retardant slurry:

Prepare 10 parts of silicon dioxide, 0.2 parts of naphthalenesulfonate salt, 0.2 parts of sodium dodecylbenzenesulfonate, and 0.1 parts of sodium hexametaphosphate. Add the naphthalenesulfonate salt, the sodium dodecylbenzenesulfonate, and the sodium hexametaphosphate to 55% NMMO separately and mix uniformly. Then, add 10 parts of modified 1,4-bis(2-oxo-4-methoxy-5,5-dimethyl-1,3,2-dioxaphosphorinan-2-amino) piperazine, uniformly disperse them by mechanical stirring for 0.5 h, and grind at 20° C. at a grinding speed of 1400 rpm, such that flame retardant particles have a particle size distribution of X10 less than 1 μm and X90 less than 10 μm. Subsequently, slowly add the silicon dioxide, as well as 2 parts of an ethanol solution of γ-(2,3-epoxypropoxy) propyltrimethoxysilane, wherein a concentration of the γ-(2,3-epoxypropoxy) propyltrimethoxysilane in the ethanol solution is 0.05 mol/L, and continue grinding until the flame retardant particles in a compounded flame retardant slurry have a particle size distribution of X10 less than 0.5 μm and X90 less than 3.0 μm, with a solid content of the flame retardant in the slurry being 15%.
(3) Preparation of a flame-retardant regenerated cellulose fiber:

Uniformly mix the compounded flame retardant slurry obtained in step (2) with an NMMO aqueous solution having a mass concentration of 70%, and then add wood pulp with a degree of polymerization of 650 thereto, mix, and disperse uniformly to form a suspension of a flame retardant/cellulose/NMMO aqueous solution, which is then subjected to dehydration swelling and dissolution processes to prepare a uniform flame-retardant Lyocell cellulose spinning solution; the swelling and dehydration temperature is 80° C., and the dehydration pressure is 11.5 KPa; the dissolution and dehydration temperature is 102° C., and the dehydration pressure is 5.2 KPa; the viscosity of the spinning solution is 25000 poise, the content of the flame retardant is 22 wt % of the weight of the cellulose, and the content of the cellulose is 11 wt % of the weight of the spinning solution. Degas and filter the obtained spinning solution, then extrude it through a spinneret into a coagulation bath for forming, followed by stretching, washing, oiling, and drying to obtain compounded phosphorus-nitrogen-based flame-retardant Lyocell fiber. The composition of said coagulation bath is 15% NMMO aqueous solution, and the coagulation temperature is 20° C. The fiber indicators are shown in Table 1.

TABLE 1

| | | | | Limiting |
|---|---|---|---|---|
| | | | | oxygen index % |
| | | Dry | Wet | (After 30 |
| | Fineness | strength | strength | washing |
| Item | (dtex) | cN/dtex | cN/dtex | cycles) |
| Embodiment 1 | 1.7 | 2.14 | 1.67 | 28.5 |
| Embodiment 2 | 2.0 | 2.52 | 1.78 | 28.8 |
| Embodiment 3 | 1.72 | 2.25 | 1.58 | 29.2 |
| Embodiment 4 | 1.8 | 2.2 | 1.52 | 29 |
| Embodiment 5 | 2.0 | 3.28 | 2.43 | 29.5 |
| Embodiment 6 | 1.8 | 3.20 | 2.08 | 29.2 |
| Embodiment 7 | 2.0 | 3.17 | 2.15 | 29.6 |
| Embodiment 8 | 2.2 | 3.85 | 2.81 | 30.2 |
| Comparative | 1.75 | 1.95 | 1.42 | 23 (Produces heavy |
| example 1 | | | | smoke when exposed to |
| | | | | fire) |
| Comparative | 2.0 | 2.0 | 1.58 | 25 (Produces heavy |
| example 2 | | | | smoke when exposed to |
| | | | | fire) |
| Comparative | 1.85 | 2.21 | 1.70 | Burns into ashes when |
| example 3 | | | | exposed to fire |
| Comparative | 1.72 | 2.72 | 1.95 | 22.8 (Produces heavy |
| example 4 | | | | smoke when burning in |
| | | | | fire) |
| Comparative | 2.0 | 2.95 | 2.08 | 27 (Produces heavy |
| example 5 | | | | smoke when exposed to |
| | | | | fire) |
| Comparative | 2.2 | 4.12 | 3.58 | Burns into ashes when |
| example 6 | | | | exposed to fire |
| Comparative | 1.72 | 3.20 | 2.33 | Burns into ashes when |
| example 7 | | | | exposed to fire |
| Comparative | 1.70 | 1.90 | 1.15 | 28.5 |
| example 8 | | | | |
| Comparative | 2.0 | 3.25 | 2.45 | Burns into ashes when |
| example 9 | | | | exposed to fire |
| Comparative | 2.2 | 3.78 | 2.75 | 31 |
| example 10 | | | | |
| Comparative | 2.2 | 3.58 | 2.42 | 25.1 (Produces heavy |
| example 11 | | | | smoke when exposed to |
| | | | | fire) |

Analysis of results:

Compared with embodiment 1-8, comparative examples 1, 2, 4, and 5 do not contain inorganic compounds, do not contain modifying agents. The fiber produces heavy smoke when burning in fire. Mechanical properties are reduced. After many times of washing, the flame retardant properties decrease, producing heavy smoke when burning in air.

Compared with embodiment 1-8, comparative examples 3 and 6 do not contain flame retardants. The fiber has no flame retardant effect, and burns into ashes when exposed to fire.

Compared with embodiment 7, comparative example 7 only adds unmodified inorganic compounds as flame retardants. Since the total amount of flame retardant added is the same, the mechanical properties of the fiber remain essentially unchanged, but the fiber has no flame retardant effect and burns into ashes when exposed to fire.

Compared with embodiment 3, comparative example 8 does not add inorganic compounds and only uses modified phosphoramide ester compounds as flame retardants. The fiber produces heavy smoke when burning, and due to the absence of a small number of inorganic compounds that would provide reinforcement, the mechanical properties of the fiber are lower.

Compared with embodiment 5, comparative example 9 only adds modified inorganic compounds as flame retardants. Since the total amount of flame retardant added is the same, the mechanical properties of the fiber remain essentially unchanged, but the fiber has no flame retardant effect and burns into ashes when exposed to fire.

Compared with Embodiment 8, Comparative Example 10 reduces the amount of inorganic compounds added. With the total amount of flame retardant unchanged, the flame retardant performance of the fiber improves, but the mechanical properties decrease. Comparative example 11 increases the number of inorganic compounds, resulting in decreased flame retardant performance of the fiber, increased smoke production during burning, and due to the significant increase in inorganic compounds, the nano effect becomes apparent, leading to a slight decrease in the spinnability of the spinning solution, thereby reducing the mechanical properties of the fiber.

Therefore, as can be seen from Table 1, the flame-retardant regenerated cellulose fibers prepared using the present invention have excellent mechanical properties and flame retardant performance, produce less smoke during combustion, and the flame-retardant fibers still maintain good flame retardant performance after many times of washing, indicating good durability of the fibers. Using the preparation method of the present invention, the spinning solution has good filterability and spinnability, which is very practical in large-scale industrial production, and the technical solution of the present invention has significant beneficial effects.

The foregoing are merely preferred embodiments of the present invention and are not a limitation of the present invention in any form. Although the present invention has been disclosed as above according to the preferred embodiments, however, it is not used to limit the present invention. Any person skilled in the art of this invention may use the technical content of the above hints to make some changes or modifications to equivalent embodiments without departing from the scope of the technical solution of the present invention, but the content without departing from the technical solutions of the present invention, and any simple modifications, equivalent changes and modifications to the above embodiments on the basis of the technical substance of the present invention all still fall within the scope of the present invention.

1. A compounded phosphorus-nitrogen-based flame retardant, characterized in that it comprises a compounded mixture of a phosphoramide ester compound and an inorganic compound, wherein a mass ratio of said phosphoramide ester compound and said inorganic compound is (10-35):(0.1-10);
Preferably, the mass ratio of said phosphoramide ester compound and said inorganic compound is (10-30):(0.1-10);
More preferably, the mass ratio of said phosphoramide ester compound and said inorganic compound is (10-25):(0.1-10).

2. The compounded phosphorus-nitrogen-based flame retardant according to claim 1, characterized in that a structural formula of said phosphoramide ester compound is as shown in formula (1): 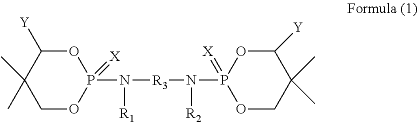
Where:
X is selected from oxygen or sulfur,
Y is selected from a hydrogen atom, an aryl group, or a methoxy group,
R₁ and R₂ are selected from an independent hydrogen atom, an alkyl group, an aryl group, a substituted alkyl group, or a substituted aryl group,
R3 is selected from an alkylene group, an aryl group, or a substituted aryl group,
Among them, R1, R2, R3, and a nitrogen atom connected thereto can form a nitrogen-containing heterocyclic structure.

3. The compounded phosphorus-nitrogen-based flame retardant according to claim 1, characterized in that said inorganic compound is selected from a mixture of one or more of carbon compounds, clay minerals, silicon-based compounds, boron-containing compounds, and metal compounds,
Preferably, said carbon compound is selected from one or more of graphene, fullerene, and carbon nanotubes,
Said clay mineral is selected from one or more of montmorillonite, kaolin, bentonite, talc, muscovite, and diatomaceous earth,
Said silicon-based compound is selected from one or more of silicon dioxide, sodium silicate, magnesium silicate, aluminum silicate, and calcium silicate,
Said boron-containing compound is selected from one or more of zinc borate and boron nitride,
Said metal compound is selected from one or more of titanium oxide, zinc oxide, magnesium oxide, aluminum sulfate, aluminum hydroxide, and magnesium hydroxide,
Preferably, said inorganic compound exists in the form of particles, wherein the particles have an initial particle size distribution with X90 of less than 50 μm; preferably, have an initial particle size distribution with X90 of less than 10 μm; more preferably, have an initial particle size distribution with X90 of less than 5 μm.

4. The compounded phosphorus-nitrogen-based flame retardant according to claim 1, characterized in that it further comprises a dispersing aid and a modifying agent, wherein a mass ratio of said phosphoramide ester compound to said modifying agent is 1:(0.01-10); preferably 1:(0.01-5.0), more preferably 1:(0.01-2.0),
Preferably, said dispersing aid is selected from a mixture of at least two or more of naphthalene sulfonates, sodium dodecylbenzene sulfonate, sodium alpha-olefin sulfonate, sodium lignosulfonate, sodium dodecyl sulfate, water-soluble polyesters, polycarboxylates, sodium polyacrylate, polyoxyethylene ether compounds, polyalkylsiloxane compounds, aliphatic-aromatic block copolymers, styrene-maleic anhydride modified copolymers, styrene-acrylic acid modified copolymers, sodium metaphosphate, sodium tripolyphosphate, and sodium pyrophosphate,
Preferably, said modifying agent is at least one of an alkane compound or an organosilicon compound,
Preferably, said alkane compound is a small molecule alkane compound containing an organic group; preferably, a small molecule alkane compound containing a small amount of carboxyl or mercapto groups,
Preferably, said organosilicon compound is selected from a siloxane solution or a siloxane coupling agent; preferably, said siloxane solution is a polymerized or non-polymerized siloxane compound, preferably an oligosiloxane compound containing hydrogen, methoxy, ethoxy, etc.; said siloxane coupling agent is a siloxane coupling agent containing a methoxy, ethoxy, or acyloxy group, preferably a siloxane coupling agent containing a small amount of vinyl, amino, epoxy, or mercapto groups.

5. The compounded phosphorus-nitrogen-based flame retardant according to claim 1, characterized in that the preparation method of a compounded phosphorus-nitrogen-based flame retardant comprises: adding a dispersing aid to a dispersion medium and mixing uniformly, then adding a phosphoramide ester compound, uniformly dispersing for 0.5-5 h by means of ultrasonic dispersion or mechanical stirring, followed by performing a first grinding; subsequently adding an inorganic compound and a modifying agent, and performing a second grinding to obtain a slurry of the compounded phosphorus-nitrogen-based flame retardant,
Preferably, the first grinding causes particles to have a particle size distribution with X10 of less than 1 μm and X90 of less than 10 μm; the second grinding is performed until the particles in the compounded flame retardant slurry have a particle size distribution with X10 of less than 0.5 μm and X90 of less than 5.0 μm.

6. The compounded phosphorus-nitrogen-based flame retardant according to claim 5, characterized in that the phosphoramide ester compound is added directly, or the phosphoramide ester compound is first pretreated and modified before being added,
Preferably, the method for pretreating and modifying said phosphoramide ester compound comprises: uniformly dispersing the phosphoramide ester compound in a mixed solution of water and ethanol, then adding a silicate ester and a modifying agent, and pretreating at 25-70° C. for 0.5-12 h, followed by filtering, washing, and drying to obtain a modified phosphoramide ester compound,
Preferably, in said mixed solution of water and ethanol, a volume ratio of water to ethanol is 1:(0.1-10),
Preferably, said silicate ester is at least one of tetraethyl orthosilicate, tetramethyl orthosilicate, tetrapropyl orthosilicate, or tetrabutyl orthosilicate,
Preferably, a mass ratio of said phosphoramide ester compound to said silicate ester is 1:(0.1-10),
Preferably, a mass ratio of said phosphoramide ester compound to said modifying agent is 1:(0.01-10); preferably, the mass ratio is 1:(0.01-5.0), more preferably; the mass ratio is 1:(0.01-2.0).

7. The compounded phosphorus-nitrogen-based flame retardant according to claim 5, characterized in that said modifying agent is added in the form of an ethanol solution, wherein in said ethanol solution, a molar concentration of the modifying agent is 0.01-1 mol/L, preferably 0.01-0.1 mol/L.

8. The compounded phosphorus-nitrogen-based flame retardant according to claim 5, characterized in that in said slurry of the compounded phosphorus-nitrogen-based flame retardant, a total mass of said phosphoramide ester compound, said inorganic substance, and said modifying agent accounts for 10-30% of a total mass of the slurry, a mass of the dispersing aid accounts for 0.5-20% of the total mass of the slurry, and the remainder is a dispersion medium,
Preferably, said dispersion medium is at least one of deionized water, an ethanol solution, or an N-methylmorpholine-N-oxide solution.

9. A compounded phosphorus-nitrogen-based flame-retardant regenerated cellulose fiber, characterized in that components of the regenerated cellulose fiber comprise cellulose and a flame retardant dispersed within a cellulose fiber matrix, wherein said flame retardant is the compounded phosphorus-nitrogen-based flame retardant as described in claim 1.
Preferably, in said regenerated cellulose fibers, a mass ratio of the flame retardant to the cellulose is (15-50):100; preferably, the mass ratio is (15-35):100; more preferably (15-30):100.
Preferably, said regenerated cellulose fibers have a dry breaking strength of ≥2.0 cN/dtex, a wet breaking strength of ≥1.5 cN/dtex, and a limiting oxygen index value of ≥28%.

10. A preparation method of compounded phosphorus-nitrogen-based flame-retardant regenerated cellulose fibers, characterized in that it comprises:
(1) Preparing a slurry of a compounded phosphorus-nitrogen-based flame retardant using the preparation method described in claim 5;
(2) Mixing the obtained slurry of the compounded phosphorus-nitrogen-based flame retardant with a suspension of cellulose or a cellulose solution, and dispersing uniformly to prepare a flame-retardant cellulose spinning solution, which is extruded through a spinneret into a coagulation bath for forming, followed by stretching, washing, oiling, and drying to obtain the compounded phosphorus-nitrogen-based flame-retardant regenerated cellulose fibers.
Preferably, in step (2), the cellulose solution comprises a cellulose xanthate solution, a solution of cellulose in N-methylmorpholine-N-oxide, a solution of cellulose in an ammonia solution of copper hydroxide or copper salt, or a solution of cellulose in an ionic liquid.
Preferably, components of said coagulation bath comprise sulfuric acid, sodium sulfate, zinc sulfate; or, said coagulation bath is an NMMO aqueous solution.
